(19) United States
(12) Patent Application Publication
(10) Pub. No.: US 2018/0048828 A1
(43) Pub. Date: Feb. 15, 2018

(54) Method for capturing image(s), related computer program and electronic system for capturing a video

(71) Applicant: PARROT DRONES, Paris (FR)

(72) Inventors: Henri Seydoux, Paris (FR); Frédéric Pirat, Paris (FR); Arnaud Chauveur, Rueil Malmaison (FR)

(21) Appl. No.: 15/672,775

(22) Filed: Aug. 9, 2017

(30) Foreign Application Priority Data
Aug. 11, 2016 (FR) 16 57728

(51) Int. Cl. H04N 5/232; B64D 47/08; G01C 21/18; B64C 39/02

(52) U.S. Cl. CPC H04N 5/23296; B64C 39/024; B64D 47/08; G01C 21/18; B64C 2201/021; B64C 2201/127; B64C 2201/146; G05D 1/0038

(57) ABSTRACT

The invention relates to a method for capturing a video using a camera on board a fixed-wing drone, the camera comprising an image sensor, the fixed-wing drone comprising an inertial unit configured to measure the roll angle, the pitch angle and/or the yaw angle of the fixed-wing drone 57858. This method comprises obtaining one or more images corresponding to a zone of the sensor with reduced dimensions relative to those of the sensor and associated with a shot reference, the position of the zone being determined from the orientation of the shot reference obtained as a function of the roll angle, the pitch angle and/or the yaw angle of the fixed-wing drone.

This application claims priority from French Patent Application No. 16 57728 filed on Aug. 11, 2016. The content of this application is incorporated herein by reference in its entirety.

### BACKGROUND

The present invention relates to a method for capturing a video using a camera on board a fixed-wing drone, the camera comprising an image sensor.

In particular, the fixed-wing drone is of the “sailwing” type. Hereinafter, a “drone” refers to an aircraft with no pilot on board. A drone is autonomous or piloted remotely, in particular using a control stick.

The invention also relates to a computer program including software instructions which, when executed by a computer, carry out such a method for capturing a video.

The invention also relates to an electronic system for capturing a video comprising a fixed-wing drone and a camera on board the fixed-wing drone, the camera comprising an image sensor.

Rotary-wing drones are known, for example of the quadcopter kind, which may hold a fixed point and move as slowly as desired, which makes them much easier to pilot, even for inexperienced users.

Fixed-wing drones, more particularly those of the “sailwing” type, can move at high speeds, typically up to 80 km/h, and are, compared with rotary-wing drones, fairly difficult to pilot in light of their very high reactivity to piloting instructions sent from the control stick, and the need to maintain a minimum flight speed, greater than the takeoff speed.

These difficulties are fairly critically increased in the case of rotary-wing drones. Indeed, these drones have no empennage and vertical stabilizer, and therefore have no movable vertical steering control surface (such as a flap placed on the vertical stabilizer, in the case of a conventional aircraft). The sailwing is provided, by way of control surfaces, with only two moving flaps placed on the trailing edges of the wings: movements of these flaps in the same direction modify the pitch attitude (angle θ) of the drone, while movements in the opposite direction of these two flaps modify the roll attitude (angle φ) of the drone, and the latter does not have other aerodynamic trajectory control means, aside from the control of the engine rating.

To make the drone move, the user must therefore control, from his control stick, the position of the two flaps to modify the pitch and roll attitude of the drone, this modification potentially being accompanied by an increase or decrease in the speed.

Such a piloting mode is in no way easy or intuitive, and the difficulty is further increased by the very unstable nature, in particular on turns, of a sailwing relative to an aircraft provided with a vertical stabilizer.

Solutions have been developed to allow a user, even a beginning user, to optimize the piloting of fixed-wing drones, in particular a drone of the sailwing type. Such solutions are based on the use by the user of simple fight commands (hereinafter “piloting instructions”), such as “turn right” or “turn left”, “rise” or “lower”, “accelerate” or “slow down”, these instructions for example being generated using joysticks of the control stick.

It is also possible to provide such a fixed-wing drone with equipment for performing specific tasks. It is in particular possible to equip the fixed-wing drone with a camera having an image sensor, to take videos.

The image sensor is for example associated with a hemispherical lens of the fisheye type, i.e., covering a viewing field with a wide angle, of about 180° or more. The camera comprises the image sensor and the lens positioned in front of the image sensor such that the image sensor detects the images through the lens.

The video camera of the drone can be used for piloting in “immersion mode”, i.e., where the user uses the image from the camera in the same way as if he was himself on board the drone. It may also be used to capture sequences of images of a scene toward which the drone is moving.

It is desirable for the images obtained using the camera to be obtained in the relevant shot reference with respect to flight phase of the drone, without modifying the physical orientation of the camera, which remains immobile relative to the fixed-wing drone.

Hereinafter, “flight phase” refers to a characteristic flight status (i.e., flight scenario) of the drone, comprising the absence of flight (i.e., the fixed-wing drone is on the ground), a flight status being identified by a set of parameters, different from one flight status to another.

Indeed, depending on the flight phase of the fixed-wing drone, i.e., for example, a flight phase during which the fixed-wing drone is turning, flying in a straight line, ascending, descending, taking off, landing, according to piloting instructions from the user, it is not relevant for the shot reference, imposing the pointing direction of the camera, to remain invariable.

One of the aims of the invention is then to propose a method for capturing a video using a camera on board a fixed-wing drone, the camera comprising an image sensor, allowing the user to acquire shots adapted to the flight phases in order to make the video more pleasant, in particular when the user is wearing a first-person view (FPV) system.

To that end, the invention relates to a method for capturing a video using a camera on board a fixed-wing drone, the camera comprising an image sensor, the fixed-wing drone comprising an inertial unit configured to measure the roll angle, the pitch angle and/or the yaw angle of the fixed-wing drone, the method comprising obtaining one or more images corresponding to a zone of the sensor with reduced dimensions relative to those of the sensor and associated with a shot reference, the position of the zone being determined from the orientation of the shot reference obtained as a function of the roll angle, the pitch angle and/or the yaw angle of the fixed-wing drone.

The video capture method according to the invention makes it possible to obtain a video using the camera on board a fixed-wing drone oriented in an optimized direction irrespective of the flight phase (i.e., status), the attitude of which is characterized by at least one of the Euler angles, namely the pitch angle, the roll angle and the yaw angle.

In other words, the method according to the invention makes it possible to adjust the direction targeted by the camera on board the fixed-wing drone based on the current flight phase.

The shot is therefore optimized irrespective of the flight phase of the fixed-wing drone. The playback of the video is then improved for the user. Better user assistance is also obtained during piloting, in particular when the user essentially bases his piloting on the real-time playback of the images filmed by the camera.

According to other advantageous aspects of the invention, the video capture method comprises one or more of the following features, considered alone or according to all technically possible combinations:

when the drone is on the ground, the orientation of the shot reference is equal to that of the drone,

during a takeoff phase of the drone and/or during a landing phase of the drone, the orientation of the shot reference is equal to the attitude of the drone filtered by a low-pass filter,

when the drone flies along a straight path and at a constant altitude, the shot reference has a zero roll angle, a zero pitch angle and a yaw angle configured to orient the shot in a fixed direction corresponding to the direction of the travel of the drone at the end of the last turn performed by the drone,

when the drone turns, the shot reference has a roll angle corresponding to a roll setpoint followed by the drone, a zero pitch angle, and a yaw angle of the drone filtered by a low-pass filter,

when the drone is ascending or descending along a straight path, the shot reference has a zero roll angle, a pitch angle equal to a pitch setpoint followed by the drone, and a yaw angle determined to orient the shot in a fixed direction corresponding to the direction of the travel of the drone at the end of the last turn performed by the drone,

when the drone is ascending or descending while turning, the shot reference has a roll angle corresponding to a roll setpoint followed by the drone, a pitch angle equal to a pitch setpoint followed by the drone, and a yaw angle of the drone filtered by a low-pass filter,

when the drone flies along a straight path and at a constant altitude and begins a turn, the shot reference has a roll angle equal to a roll setpoint followed by the drone, a zero pitch angle and a yaw angle determined to orient the shot in a fixed direction corresponding to the direction of the travel of the drone at the end of the last turn performed by the drone,

when the drone is ascending or descending following a straight path and begins a turn, the shot reference has a roll angle equal to a roll setpoint followed by the drone, a pitch angle equal to a pitch setpoint followed by the drone, and a yaw angle determined to orient the shot in a fixed direction corresponding to the direction of the travel of the drone at the end of the last turn performed by the drone,

when the drone flies along a straight path and at a constant altitude with a misalignment relative to the target path, the shot reference has a zero roll angle, a zero pitch angle, and a yaw angle of the drone filtered by a low-pass filter,

when the drone is ascending or descending while following a straight path with a misalignment relative to the target path, the shot reference has a zero roll angle, a pitch angle equal to a pitch setpoint followed by the drone, and a yaw angle of the drone filtered by a low-pass filter,

during the transitional period between at least two shot reference orientations respectively associated with at least two flight phases, the orientation of the shot reference during the transitional period is obtained by applying a spherical linear interpolation comprising at least one weight relative to at least one weight coefficient, the value of which evolves gradually over the course of the transitional period.

The invention also relates to a computer program comprising software set points which, when executed by a computer, carry out a method as defined above.

The invention also relates to an electronic system for capturing a video comprising a fixed-wing drone and a camera on board the drone, the camera comprising an image sensor, the fixed-wing drone comprising an inertial unit configured to measure the roll angle, the pitch angle and/or the yaw angle of the fixed-wing drone, the electronic video capture system further comprising an obtaining module configured to obtain at least one image corresponding to a zone of the sensor with smaller dimensions relative to those of the sensor and associated with a shot reference, the obtaining module being configured to determine the position of the zone from the orientation of the shot reference obtained as a function of the roll angle, the pitch angle and/or the yaw angle of the fixed-wing drone.

These features and advantages of the invention will appear more clearly upon reading the following description, provided solely as a non-limiting example, and done in reference to the appended drawings, in which:

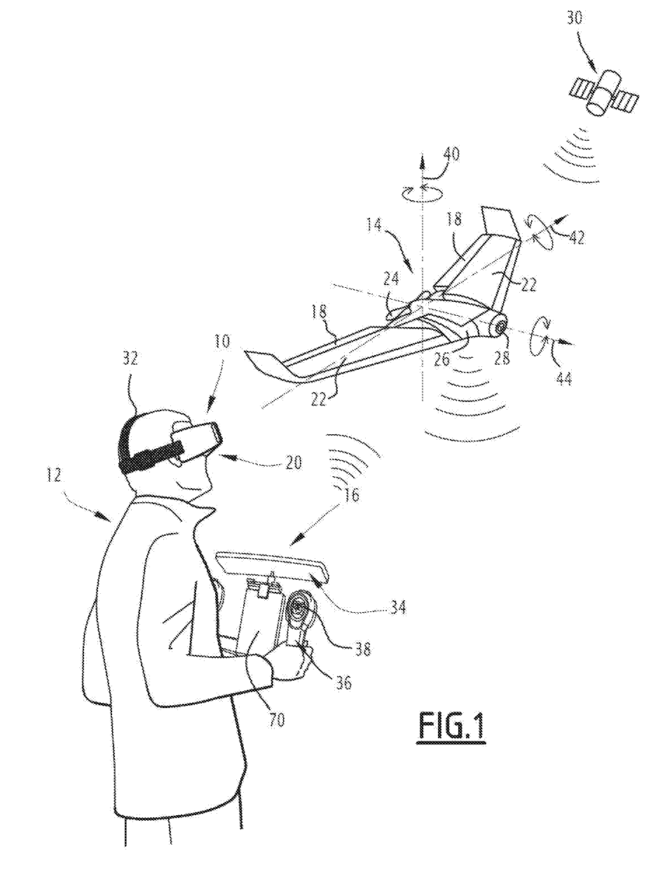

FIG. 1 is a perspective view of an electronic video capture system according to the invention, comprising a fixed-wing drone of the sailwing type, moving through the air under the control of remote control equipment;

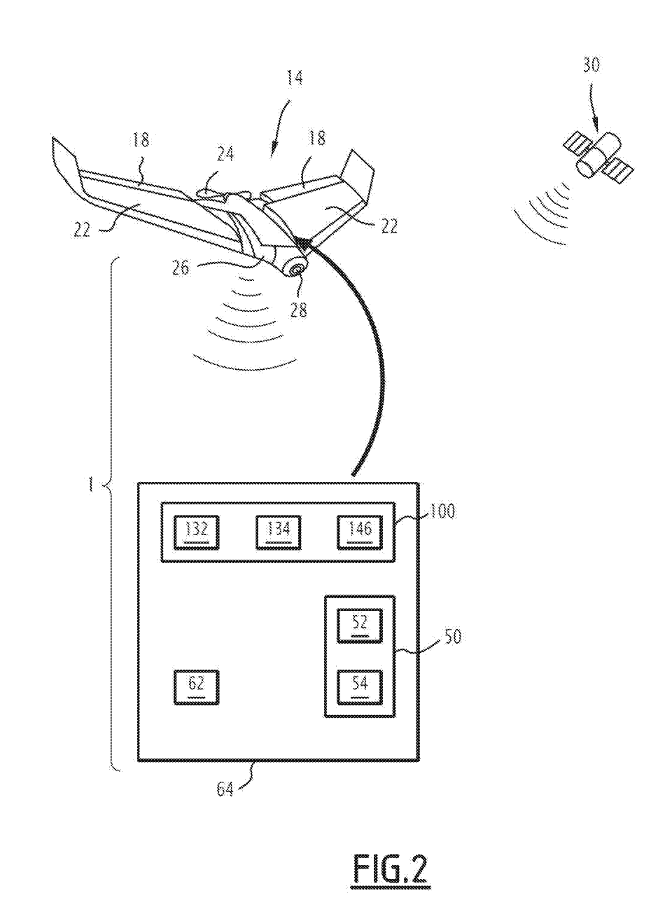

FIG. 2 is a partial schematic illustration of the modules making up the electronic system for capturing a video according to the invention;

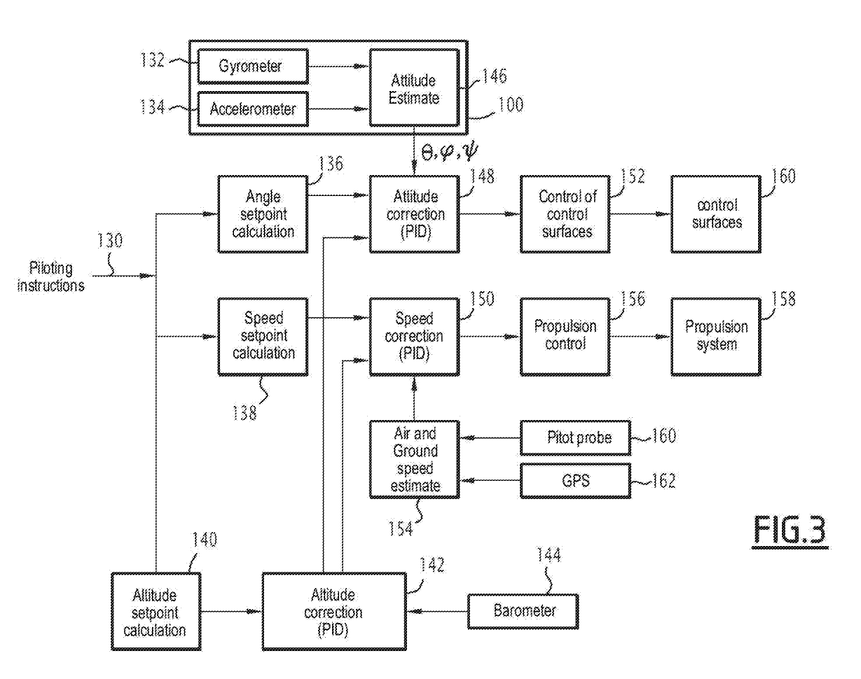

FIG. 3 is a block diagram of an automatic pilot integrated into a fixed-wing drone;

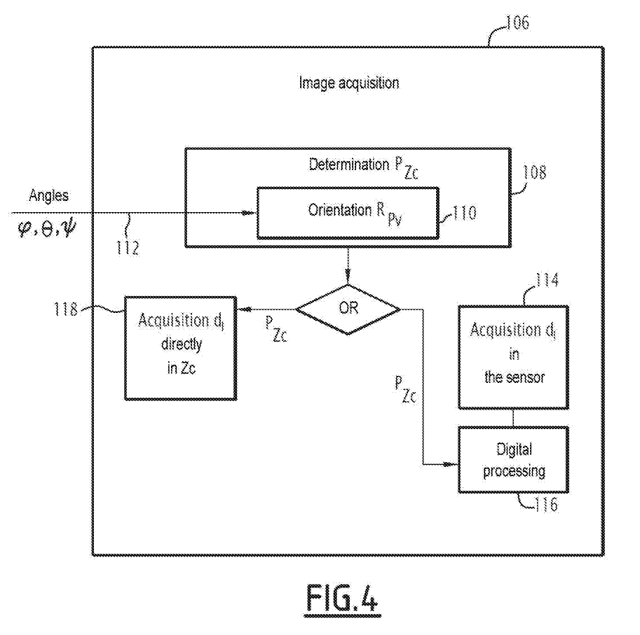

FIG. 4 is a flowchart of a method for capturing a video according to the invention;

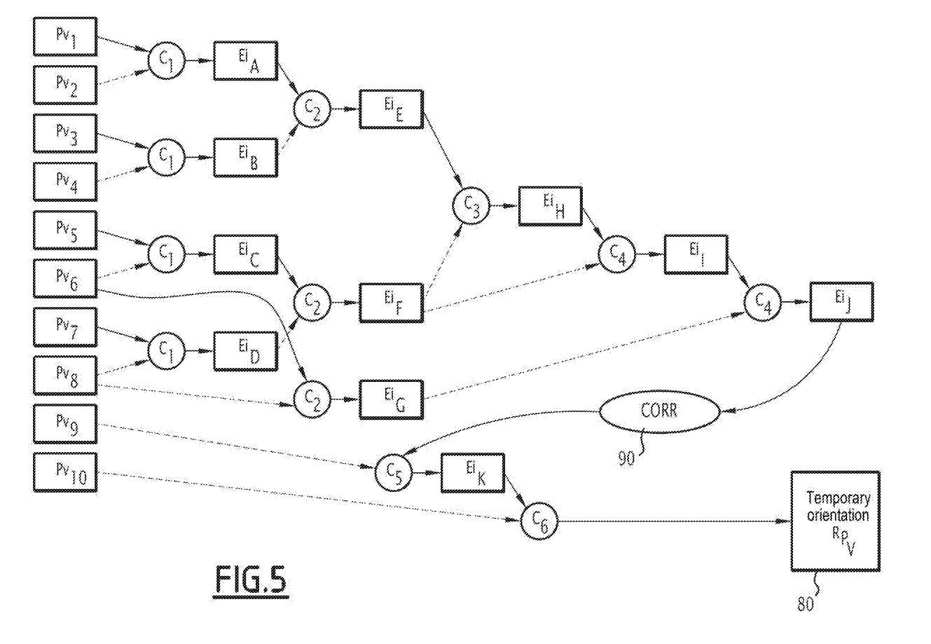

FIG. 5 is a schematic illustration of the determination of the orientation of the shot reference during a transition between at least two separate flight phases; and

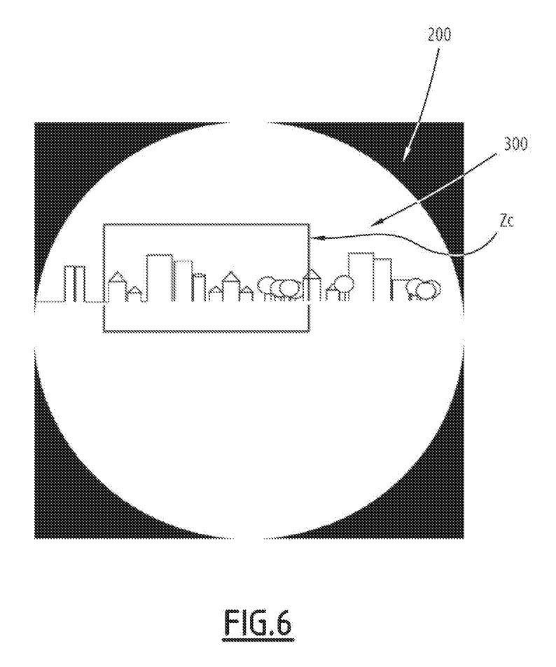

FIG. 6 is a schematic illustration of images respectively corresponding to the overall field of the camera obtained on the image sensor, the projection of the image obtained by the lens associated with the image sensor, and the zone whose position is determined according to the invention.

In FIGS. 1 and 2, an electronic video capture system 1 allows a user 12 to optimize the obtainment of images using a camera on board a drone 14, in particular a fixed-wing drone in particular of the “sailwing” type.

The fixed-wing drone 14 comprises a drone body (fuselage) 26 provided in the rear part with a propeller 24 and on the sides with two wings 22, these wings extending the drone body 26 in the illustrated configuration of the “sailwing” type. On the side of the trailing edge, the wings 22 are provided with control surfaces 18 able to be oriented using servo mechanisms to control the path of the drone.

During flight, the drone 10 moves by:
a) rotation around a pitch axis 42, to modify the altitude;
b) rotation around a roll axis 44, to turn right or left; and
c) speed, by changing the gas state.

The drone 14 is also provided with an image sensor 28 configured to acquire at least one image of a scene, and a transmission module, not shown, configured to send the image(s) acquired by the image sensor 28, preferably wirelessly, to a piece of electronic equipment, such as the reception module, not shown, of the electronic viewing system 10, the reception module, not shown, the control stick 16, or the reception module of the multimedia touchscreen digital tablet 70 mounted on the control stick 16, not shown.

The image sensor 28 is for example associated with a hemispherical lens of the fisheye type, i.e., covering a viewing field with a wide angle, of about 180° or more. The projection 300 of the image obtained by the fisheye lens associated with the image sensor 28 is shown in FIG. 6. The camera comprises the image sensor 28 and the lens positioned in front of the image sensor 28 such that the image sensor detects the images through the lens.

In the example of FIG. 2, the fixed-wing drone 14 further comprises an information processing unit 50, for example formed by a memory 52 and a processor 54 associated with the memory 52.

The fixed-wing drone 14 also comprises an inertial unit 100 configured to measure the roll angle φ, the pitch angle θ and/or the yaw angle Ψ of the fixed-wing drone 14.

In the example of FIG. 2, the inertial unit 100 comprises the gyrometer(s) 132, the accelerometer(s) 134 and the attitude estimating circuit 146, as also shown in FIG. 3, illustrating a block diagram of an automatic pilot integrated into a fixed-wing drone.

The fixed-wing drone 14 also comprises an obtaining module 62 configured to obtain at least one image corresponding to a zone Zc of the sensor with smaller dimensions relative to those of the sensor and associated with a shot reference, the obtaining module 62 being configured to determine the position P_{zc} of the zone Zc from the orientation of the shot reference obtained as a function of the roll angle, the pitch angle and/or the yaw angle of the fixed-wing drone.

The image sensor 28 is the photosensitive member of the camera. It is for example a CMOS sensor. The zone Zc is a fraction of the image sensor 28.

The image sensor 28 associated with the lens is able to provide an overall image corresponding to an overall field 200 of the camera as shown in FIG. 6. The zone Zc of the image sensor 28 corresponds to a window of the overall field with smaller dimensions relative to those of the overall field. The acquired image corresponding to the zone Zc is the image that would be acquired by this zone Zc without using the rest of the image sensor.

Obtaining an image from a zone Zc with smaller dimensions of the image sensor makes it possible to virtually orient the viewing axis of the camera in the direction of the window of the overall field of the camera corresponding to the zone Zc with smaller dimensions, without modifying the physical orientation of the camera, which remains immobile relative to the fixed-wing drone 14.

According to a first alternative, the obtaining module 62 comprises a module for acquiring image data d_{I}, not shown, configured to acquire image data from the entire surface area of the image sensor, and a digital processing module for the image data, not shown, configured to deliver video images corresponding only to the zone Zc, the position of the zone Zc being determined from the orientation of the shot reference obtained as a function of the roll angle, the pitch angle and/or the yaw angle of the fixed-wing drone 14.

According to a second alternative, the obtaining module 62 comprises only a module for acquiring image data, not shown, configured to acquire image data only in the zone Zc during the video production, the position of the zone Zc being determined from the orientation of the shot reference obtained as a function of the roll angle, the pitch angle and/or the yaw angle of the fixed-wing drone 14.

In the example of FIG. 2, the inertial unit 100 configured to measure the roll angle, the pitch angle and/or the yaw angle of the fixed-wing drone and the obtaining module 62 configured to obtain at least one image are each made so as to comprise software executable by the processor 54. The memory 52 of the information processing unit 50 is then able to store measuring software configured to measure the instantaneous attitude of the fixed-wing drone 14 defined by the roll angle, the pitch angle and/or the yaw angle, and obtaining software configured to obtain at least one image corresponding to a zone Zc with reduced dimensions relative to those of the image sensor 28, the position of the zone Zc being determined from the shot reference obtained as a function of the roll angle, the pitch angle and/or the yaw angle of the fixed-wing drone 14, and/or, depending on the flight phase, from a roll setpoint and/or a pitch setpoint.

The processor 54 of the information processing unit 50 is then able to execute the measuring software and the obtaining software using a computer program.

An electronic viewing system 10 allows the user 12 to view images, in particular images of the video received from the fixed-wing drone 14.

The electronic viewing system 10 comprises an electronic device, for example a smartphone, provided with a display screen, and a headset 20 including a reception support of the electronic device, a bearing surface against the face of the user 12, across from the user's eyes, and two optical devices positioned between the reception support and the bearing surface.

The headset 20 further includes a maintaining strap 32 making it possible to maintain the headset 20 on the head of the user 12.

The electronic device is removable with respect to the headset 20 or integrated into the headset 20.

The electronic viewing system 10 is for example connected to a control stick 16 via a data link, not shown, the data link being a wireless link or a wired link.

In the example of FIG. 1, the electronic viewing system 10 further comprises a reception module, not shown, configured to receive at least one image from the fixed-wing drone 14, the transmission of the image preferably being done wirelessly.

In an alternative that is not shown, the control stick 16 is configured to receive at least one image from the fixed-wing drone 14 and to retransmit it to the electronic viewing system 10.

The viewing system 10 is for example a virtual-reality viewing system, i.e., a system allowing the user 12 to view an image in his field of view, with a field of view (or field of vision, FOV) angle with a large value, typically greater than 90°, preferably greater than or equal to 100°, in order to procure an immersive view (also called “FPV”, First Person View) for the user 12.

The control stick 16 is known in itself, and for example makes it possible to pilot the fixed-wing drone 14. The control stick 16 comprises two gripping handles 36, each being intended to be grasped by a respective hand of the user 12, a plurality of control members, here including two joysticks 38, each being positioned near a respective gripping handle 36 and being intended to be actuated by the user 12, preferably by a respective thumb.

The control stick 16 also comprises a radio antenna 34 and a radio transceiver, not shown, for exchanging data by radio waves with the fixed-wing drone 14, both uplink and downlink.

Additionally, or alternatively in light of the viewing system 10, a digital multimedia touchscreen tablet 70 is mounted on the control stick 16 to assist the user 12 during piloting of the fixed-wing drone 14.

The control stick 16 is configured to send the piloting instructions 130 from the user to an automatic pilot integrated into the fixed-wing drone, a schematic example of which is shown in the form of a block diagram in FIG. 3.

The piloting of a fixed-wing drone 14, in particular of the “sailwing” type, is fairly difficult in light of its very high reactivity to piloting instructions sent from the control stick 16, and the need to maintain a minimum flight speed, greater than the takeoff speed.

The automatic pilot, a schematic example of which is shown in the form of a block diagram, is shown in FIG. 3, allows the use by the user of simple fight commands (hereinafter “piloting instructions”), such as “turn right” or “turn left”, “rise” or “lower”, “accelerate” or “slow down”, these instructions for example being generated using joysticks of the control stick 16. In the automatic pilot, for example illustrated by FIG. 3, a decoding module, not shown, is configured to receive the piloting instructions 130.

The output of the decoder is connected to the inputs of a module for calculating angle setpoints 136, a module for calculating speed setpoints 138, a module for calculating altitude setpoints 140 forming the automatic pilot, which are respectively configured to convert the piloting instructions 130 from the user into altitude setpoints of the drone, i.e., into roll angle setpoints, pitch angle setpoints, speed setpoints and altitude setpoints, based on an aerodynamic behavior model of the drone during flight, determined beforehand and saved in memory.

These modules 136, 138, 140 are configured to provide setpoints intended to be compared, within appropriate regulating loops, to the data produced by the sensors of the drone (inertial unit 100, geolocation module 162, speed estimator 154 from data delivered by a Pitot probe 160, barometer 144, etc. that evaluates, at all times, the actual instantaneous attitude of the drone, its altitude and its air and/or ground speed).

The regulating loops in particular comprise an attitude correction module 148, a speed correction module 150.

The attitude correction module 148 is configured to provide, as a function of data provided by an altitude correction module 142, correction data intended to be used by a control module of the control surfaces 152.

The control module of the control surfaces 152 is configured to provide appropriate commands for the servomechanisms orienting the control surfaces 160 to control the attitude of the drone.

The speed correction module 150 is configured to provide, as a function of data provided by the altitude correction module 142, correction data intended to be used by a propulsion control module 156.

The propulsion control module 156 is configured to provide appropriate commands for the propulsion surfaces 158 to control the speed of the drone.

The operation of the electronic system for capturing a video 1 according to the invention will now be described using FIG. 4, showing a flowchart of the method for capturing a video, implemented by a computer.

The method for capturing a video according to the invention allows the orientation of the viewing axis of the camera, and therefore the direction filmed by the drone, irrespective of the flight phase (i.e., flight scenario) of the fixed-wing drone 14.

When the image sensor 28 is associated with a fisheye lens, it is possible to orient the viewing axis of the camera with a sufficient angular travel, in particular to account for the attitude (defined by the triplet of pitch, roll and yaw angles) of the drone representative of the current flight scenario.

In particular, the method for capturing a video according to the invention makes it possible to define a virtual image sensor by selecting a zone Zc with smaller dimensions relative to the actual dimensions of the image sensor 28.

In FIG. 6, the images respectively corresponding to the overall field 200 of the camera obtained on the image sensor 28, the projection 300 of the image obtained by the lens associated with the image sensor, and the zone Zc whose position is determined according to the invention, are respectively shown.

During a step 106, the image(s) filmed during flight by the fixed-wing drone 14 are obtained.

More specifically, the image acquisition step 106 comprises a step 108 for determining the position P_{zc} of the zone Zc with reduced dimensions relative to the actual dimensions of the image sensor 28 from the orientation of the obtained shot reference 110 as a function of the roll angle φ, the pitch angle θ and/or the yaw angle Ψ of the fixed-wing drone 14.

In other words, the window corresponding to the zone Zc is dynamically and moved in the field of the camera produced by the image sensor 28.

More specifically, the method for capturing a video according to the invention makes it possible to offset attitude changes of the drone relative to different flight phases, by selecting the window corresponding to the zone Zc, the zone Zc being a projection in a shot reference whose instantaneous orientation relative to a fixed land reference is calculated based on the roll angle φ, the pitch angle θ and/or the yaw angle Ψ defining the attitude of the fixed-wing drone 14.

Different flight phases, shown in FIG. 5, and as many orientations of the associated shot reference according to the invention are described below and implemented alone or according to all technically possible combinations according to the piloting instructions 130 from the user 12.

For example, when the drone is on the ground, which corresponds to the flight phase Pv₁₀, of FIG. 5, the orientation of the shot reference is equal to that of the drone. In other words, the viewing axis corresponds to the axis of the camera, i.e., the longitudinal axis 44 of the fixed-wing drone 14.

During a takeoff phase and/or landing phase Pv₉ of the fixed-wing drone 14, the orientation of the shot reference is equal to that of the pitch, yaw and roll attitude of the drone filtered by a low-pass filter.

The cutoff frequency of a filter, associated with the takeoff and/or landing phase Pv₉ of the fixed-wing drone 14, is for example about 0.3 Hz in order to reduce the high frequencies causing oscillations upon video playback for the user 12.

When, during a flight phase Pv₃, the drone flies along a straight path and at a constant altitude, the shot reference has a zero roll angle, a zero pitch angle and a yaw angle configured to orient the shot in a fixed direction corresponding to the direction of the travel of the drone at the end of the last turn performed by the fixed-wing drone 14.

When, during a flight phase Pv₆, the drone turns, the shot reference has a roll angle corresponding to a roll setpoint followed by the drone, a zero pitch angle, and a yaw angle of the drone filtered by a low-pass filter.

The roll angle of the shot reference, associated with the turning flight phase Pv₆, is in particular comprised between −45° and +45°.

When, during a flight phase Pv₁, the drone is ascending or descending along a straight path, the shot reference has a zero roll angle, a pitch angle equal to a pitch setpoint followed by the drone, and a yaw angle determined to orient the shot in a fixed direction corresponding to the direction of the travel of the drone at the end of the last turn performed by the drone.

The pitch angle of the shot reference, associated with the climb or descent flight phase Pv₁ along a straight trajectory, is in particular comprised between −30° and +30°.

When, during a flight phase Pv₈, corresponding to the combination of the two preceding flight phases Pv₆ and Pv₁, the drone is ascending or descending while turning, the shot reference has a roll angle corresponding to a roll setpoint followed by the drone, a pitch angle equal to a pitch setpoint followed by the drone, and a yaw angle of the drone filtered by a low-pass filter.

The roll angle of the shot reference, associated with the climb or descent flight phase Pv₈ while turning, is in particular comprised between −45° and +45°, and the corresponding pitch angle is in particular comprised between −30° and +30°.

When, during a flight phase Pv₄, the drone flies along a straight path and at a constant altitude and begins a turn, the shot reference has a roll angle equal to a roll setpoint followed by the drone, a zero pitch angle and a yaw angle determined to orient the shot in a fixed direction corresponding to the direction of the travel of the drone at the end of the last turn performed by the drone.

The roll angle of the shot reference, associated with the flight phase Pv₄ along a straight trajectory and at a constant altitude with the beginning of a turn, is in particular comprised between −45° and +45°.

When, during a flight phase Pv₂, the drone is ascending or descending following a straight path and begins a turn, the shot reference has a roll angle equal to a roll setpoint followed by the drone, a pitch angle equal to a pitch setpoint followed by the drone, and a yaw angle determined to orient the shot in a fixed direction corresponding to the direction of the travel of the drone at the end of the last turn performed by the drone.

The roll angle of the shot reference, associated with the descent flight phase Pv₂ along a rectilinear trajectory with the beginning of a turn, is in particular comprised between −45° and +45°, and the corresponding pitch angle is in particular comprised between −30° and +30°.

The orientation of the shot reference determined according to the invention in the case of the two flight “scenarios” Pv₄ and Pv₂ described above makes it possible to avoid oscillations of the image at the beginning of a turn.

When, during a flight phase Pv₅, the drone flies along a straight path and at a constant altitude with a misalignment relative to the target path, the shot reference has a zero roll angle, a zero pitch angle, and a yaw angle of the drone filtered by a low-pass filter.

When, during a flight phase Pv₇, the drone is ascending or descending while following a straight path with a misalignment relative to the target path, the shot reference has a zero roll angle, a pitch angle equal to a pitch setpoint followed by the drone, and a yaw angle of the drone filtered by a low-pass filter.

The orientation of the shot reference determined according to the invention in the case of the two flight “scenarios” Pv₅ and Pv₇ described above makes it possible to manage the stabilization limits of the image, by preventing the viewing axis from following the movement direction of the drone when the yaw angle of the drone differs too greatly from the yaw angle associated with the target trajectory.

A correction step 90 shown in FIG. 5 also makes it possible to correct the yaw angle of the shot reference with respect to the yaw angle of the drone so that the difference between these two angles remains less than, for example, 35°.

The cutoff frequency of the low-pass filter, associated with the following types of flight phase:
turning flight Pv₆,
climbing or descending flight while turning Pv₈,
flight along a straight trajectory and at a constant altitude with misalignment Pv₅,
climbing or descending flight along a straight trajectory with misalignment Pv₇, is for example about 0.5 Hz in order to smooth the movement and reduce the high frequencies causing oscillations upon video playback for the user 12.

According to one alternative, during the following types of flight phase:
flight along a straight trajectory and at a constant altitude Pv₃, with the beginning of a turn Pv₄, or with a misalignment Pv₅,
turning flight Pv₆,
climbing or descending flight along a straight trajectory Pv₁, with the beginning of a turn Pv₂, or with misalignment Pv₇, or
climbing or descending flight while turning Pv₈, a pitch angle entered by the user is, if applicable, also taken into account (for example using addition) to modify the orientation of the shot reference.

During the transitional period between at least two shot reference orientations respectively associated with at least two different flight phases as previously described, the orientation of the shot reference during the transitional period is obtained by applying a spherical linear interpolation (SLERP) 80 comprising at least one weight relative to at least one weight coefficient, the value of which evolves gradually over the course of the transitional period.

One example of an optimized acquisition 80 of the temporary orientation of the shot reference between two different flight phases is shown in FIG. 5, and makes it possible to obtain smoothing and video stabilization without jumps during the transitional period.

In the diagram of FIG. 5, the circles show the spherical linear interpolation operations and the weight coefficient associated with each of these operations. The arrows in solid lines and the arrows in dotted lines respectively show the weight associated with each flight phase as input of the linear interpolation operation once the progression (i.e., linear increase or decrease) of the value of the weight coefficient is complete at the end of the transitional period.

The spherical linear interpolation operations embodied by the circles of FIG. 5 are carried out simultaneously or consecutively to obtain the temporary orientation of the shot reference 80, and some of them provide an intermediate flight state Ei.

Different weight coefficients, shown in FIG. 5, are described below and implemented alone or according to all technically possible combinations.

The weight coefficient C1, for example called “roll stabilization coefficient”, is in particular used for the transition between:
the climb or descent phase Pv₁ along a straight trajectory and the climb or descent phase Pv₂ along a straight trajectory with the beginning of a turn, resulting in an intermediate flight state Ei_{A},
the flight phase Pv₃ along a straight trajectory and at a constant altitude and the flight phase Pv₄ along a straight trajectory and at a constant altitude with the beginning of a turn, resulting in an intermediate flight state Ei_{B}, or
the flight phase Pv₅ along a straight trajectory and at a constant altitude with a misalignment and the turning phase Pv₆ during flight, resulting in an intermediate flight state Ei_{C},
the climb or descent flight phase Pv₇ along a straight trajectory with a misalignment and the climb or descent phase Pv₈ while turning, resulting in an intermediate flight state Ei_{D}.

The value of this weight coefficient C1 is equal to one, when no request of a roll movement (i.e., a turn command) of the drone 14 by the user 12 is present, and is zero otherwise. The escalation time of the value of the weight coefficient C1 is for example about 1.1 seconds.

The weight coefficient C2, for example called “pitch stabilization coefficient”, is in particular used for the transition between:
the intermediate flight state Ei_{A} and the intermediate flight state Ei_{B} previously described, resulting in an intermediate flight state Ei_{E},
the intermediate flight state Ei_{C} and the intermediate flight state Ei_{D} previously described, resulting in an intermediate flight state Ei_{F}, or
the turning flight phase Pv₆ and the climb or descent phase Pv₈ while turning, resulting in an intermediate flight state Ei_{G}.

The value of this weight coefficient C2 is equal to one, when no request of a pitch movement (i.e., a climb or descent command of the drone) of the drone 14 by the user 12 is present, and is zero otherwise. The escalation time of the value of the weight coefficient C2 is for example about 1.1 seconds. The value of the weight coefficient C2 begins to decrease in case of request for a pitch movement of the drone 14 by the user 12 until it becomes zero, and to increase once the pitch movement request is made.

The weight coefficient C3, for example called “alignment coefficient”, is in particular used for the transition between the intermediate flight state Ei_{E} and the intermediate flight state Ei_{F} previously described, resulting in an intermediate flight state Ei_{H}.

The value of this weight coefficient C3 is zero when the value of the yaw angle of the drone is too far from the value of the yaw angle associated with the travel of the drone, or during a turn. The value of this weight coefficient C3 is equal to 1 in case of an alignment or quasi-alignment between the direction of the travel of the drone and the attitude of the drone.

The value of this weight coefficient C3 begins to increase when, after a turn, the value of the yaw angle between the direction of the travel of the drone and its attitude is below a locking value, for example about 25°, over a predetermined locking period.

The value of this weight coefficient C3 decreases, until becoming zero, when the value of the turn stabilization coefficient C4 discussed below decreases, or when the value of the yaw angle formed between the direction of the travel of the drone and its altitude is above a value corresponding to an unlocking, for example about 35°.

The locking period is set at zero after the first turn, and increases by 1.5 seconds upon each unlocking. The weight coefficient C4, for example called “turn stabilization coefficient”, is in particular used for the transition between:
the intermediate flight state Ei_{H} and the intermediate flight state Ei_{F} previously described, resulting in an intermediate flight state Ei_{I}, or
the intermediate flight state Ei_{I} and the intermediate flight state Ei_{G} previously described, resulting in an intermediate flight state Ei_{J}.

The weight coefficient C5, for example called “stabilization coefficient”, is in particular used for the transition between a takeoff and/or landing phase Pv₉ of the fixed-wing drone 14 and the stabilized flight intermediate flight state Ei_{J} previously described.

The value of this weight coefficient C5 is zero when there is no stabilization, and for example equal to one in the presence of stabilization. The escalation time of the value of the weight coefficient C5 is for example about 1.1 seconds. The value of the weight coefficient C5 begins to increase when the takeoff phase is complete and decreases when the drone begins the landing phase until it becomes zero.

The weight coefficient C6, for example called “flight coefficient”, is in particular used for the transition between a phase Pv₁₀ where the fixed-wing drone 14 is on the ground and a takeoff/landing phase Pv₉ of the fixed-wing drone 14. When the fixed-wing drone 14 is on the ground, the value of the weight coefficient C6 is zero, whereas it is for example equal to one in the takeoff and/or landing flight phase Pv₉.

The escalation time of the value of the weight coefficient C6 is for example about two seconds. The value of the weight coefficient C6 begins to increase when a ground speed threshold is exceeded by the drone in the takeoff phase, for example 6 m.s⁻¹, and decreases once landing is complete.

When the value of the flight coefficient C6 is zero, in other words when the fixed-wing drone 14 is on the ground, the value of the set of weight coefficients C6 is also zero.

The acceleration at the beginning and end of the transition period is processed by a smoothing operation, not shown, carried out once the spherical linear interpolation operations are done.

According to one particular embodiment shown in FIG. 4, the image acquisition step 108 comprises acquiring 114 image data from all of the image sensor(s), followed by digital processing 116 of the image data delivering video images corresponding only to the zone Zc.

In other words, according to this embodiment, the digital processing is done after the capture of the image data. Such digital processing makes it possible to shift, in time, the obtaining of corrected images to be played back to the user.

According to another specific embodiment, the image acquisition step 108 comprises the acquisition 118 of image data only in the zone Zc during the production of the video, the position P_{Zc} of the zone Zc being determined during the production of the video.

In other words, according to this other embodiment, the selection of the zone Zc is implemented in real time and is made subject in real time to the orientation of the shot reference defined as a function of at least one attitude angle of the fixed-wing drone 14.

The method for capturing a video according to the invention then makes it possible to optimize the piloting of the drone by making the position of the zone Zc subject to the orientation of the shot reference defined as a function of at least one attitude angle of the fixed-wing drone 14 so as to deliver the images filmed by the drone, on which the user 12 bases his piloting, in real time.

The images obtained using the camera on board the fixed-wing drone 14 are returned in stabilized form, in particular through the use of the virtual-reality viewing system 10.

The method for capturing a video according to the invention consequently makes it possible to improve the ergonomics of the first-person view (FPV).

The “user experience” in the first-person view piloting configuration therefore allows the user 12 to optimize his piloting, since the shot is optimal irrespective of the flight phase of the drone.

1. A method for capturing a video using a camera on board a fixed-wing drone, the camera comprising an image sensor, the fixed-wing drone comprising an inertial unit configured to measure the roll angle, the pitch angle and/or the yaw angle of the fixed-wing drone,
the method comprising obtaining one or more images corresponding to a zone of the sensor with reduced dimensions relative to those of the sensor and associated with a shot reference, the position of the zone being determined from the orientation of the shot reference obtained as a function of the roll angle, the pitch angle and/or the yaw angle of the fixed-wing drone.

2. The method according to claim 1, wherein, when the drone is on the ground, the orientation of the shot reference is equal to that of the drone.

3. The method according to claim 1, wherein, during a takeoff phase of the drone and/or during a landing phase of the drone, the orientation of the shot reference is equal to the attitude of the drone filtered by a low-pass filter.

4. The method according to claim 1, wherein, when the drone flies along a straight path and at a constant altitude, the shot reference has a zero roll angle, a zero pitch angle and a yaw angle configured to orient the shot in a fixed direction corresponding to the direction of the travel of the drone at the end of the last turn performed by the drone.

5. The method according to claim 1, wherein, when the drone turns, the shot reference has a roll angle corresponding to a roll setpoint followed by the drone, a zero pitch angle, and a yaw angle of the drone filtered by a low-pass filter.

6. The method according to claim 1, wherein, when the drone is ascending or descending along a straight path, the shot reference has a zero roll angle, a pitch angle equal to a pitch setpoint followed by the drone, and a yaw angle determined to orient the shot in a fixed direction corresponding to the direction of the travel of the drone at the end of the last turn performed by the drone.

7. The method according to claim 1, wherein, when the drone is ascending or descending while turning, the shot reference has a roll angle corresponding to a roll setpoint followed by the drone, a pitch angle equal to a pitch setpoint followed by the drone, and a yaw angle of the drone filtered by a low-pass filter.

8. The method according to claim 1, wherein, when the drone flies along a straight path and at a constant altitude and begins a turn, the shot reference has a roll angle equal to a roll setpoint followed by the drone, a zero pitch angle and a yaw angle determined to orient the shot in a fixed direction corresponding to the direction of the travel of the drone at the end of the last turn performed by the drone.

9. The method according to claim 1, wherein, when the drone is ascending or descending following a straight path and begins a turn, the shot reference has a roll angle equal to a roll setpoint followed by the drone, a pitch angle equal to a pitch setpoint followed by the drone, and a yaw angle determined to orient the shot in a fixed direction corresponding to the direction of the travel of the drone at the end of the last turn performed by the drone.

10. The method according to claim 1, wherein, when the drone flies along a straight path and at a constant altitude with a misalignment relative to the target path, the shot reference has a zero roll angle, a zero pitch angle, and a yaw angle of the drone filtered by a low-pass filter.

11. The method according to claim 1, wherein, when the drone is ascending or descending while following a straight path with a misalignment relative to the target path, the shot reference has a zero roll angle, a pitch angle equal to a pitch setpoint followed by the drone, and a yaw angle of the drone filtered by a low-pass filter.

12. The method according to claim 1, wherein during the transitional period between at least two shot reference orientations respectively associated with at least two flight phases, the orientation of the shot reference during the transitional period is obtained by applying a spherical linear interpolation comprising at least one weight relative to at least one weight coefficient, the value of which evolves gradually over the course of the transitional period.

13. A computer program product comprising software instructions for implementing a method according to claim 1.

14. An electronic system for capturing a video comprising a fixed-wing drone and a camera on board the drone, the camera comprising an image sensor, the fixed-wing drone comprising an inertial unit configured to measure the roll angle, the pitch angle and/or the yaw angle of the fixed-wing drone,
wherein the electronic video capture system further comprises an obtaining module configured to obtain at least one image corresponding to a zone of the sensor with smaller dimensions relative to those of the sensor and associated with a shot reference, the obtaining module being configured to determine the position of the zone from the orientation of the shot reference obtained as a function of the roll angle, the pitch angle and/or the yaw angle of the fixed-wing drone.
